(19) United States
(12) Patent Application Publication
(10) Pub. No.: US 2013/0007203 A1
(43) Pub. Date: Jan. 3, 2013

(54) Cloud-based Communication Device and Smart Mobile Device Using Cloud-based Communication Device

(75) Inventor: Hsing-Chung SZU, Taipei (TW)

(73) Assignee: GCCA INC., Tortola (VG)

(21) Appl. No.: 13/408,585

(22) Filed: Feb. 29, 2012

(30) Foreign Application Priority Data
Jun. 30, 2011 (TW) 100123177

(51) Int. Cl. G06F 15/16

(52) U.S. Cl. 709/217

(57) ABSTRACT

The present invention provides a cloud-based communication device, including a processor; a primary operating system implanted in the cloud-based communication device; a virtual operating system or program executed by the processor and generating display data, wherein the primary operating system is different from the virtual operating system or program, the display data instructing a smart mobile device to display a graphical user interface related to the operating system or the program of the smart mobile device simulated by the virtual operating system or program; a transmission module coupled to the processor to transmit the display data to the smart mobile device through a network; a receiving module coupled to the processor to receive the control signals transmitted from the smart mobile device though the network to control the graphical user interface of the virtual operating system or program.

### FIELD OF THE INVENTION

The present invention relates to a smart mobile device, and more particularly to a cloud-based communication device and a smart mobile device using the cloud-based communication device.

### BACKGROUND OF THE INVENTION

Smart mobile devices have developed increasingly. Especially, tablet PCs and smart mobile phones have been the fastest growing devices. Nowadays, it is not surprised that every person has a smart mobile phone or a tablet PC. To satisfy the diversified demands of the users, smart mobile devices have to execute various kinds of programs, for example programs for web pages, blogs, on-line videos, on-line music, radios, stock market quotations, web calls, video news or text news, which all need a quite large amount of computation. Therefore, the power consumption rate of the smart mobile devices generally is too high, resulting in that smart mobile devices commonly have to be recharged after 1-2 days of use.

To solve the above-mentioned problems, various kinds of portable power devices have appeared in the markets in order for the users to utilize the portable power devices to recharge the smart mobile devices on the move. However, it is a temporary, not a permanent solution to the issue. The portable power devices do not solve the basic problem of the smart mobile devices, i.e. the excessively high consumption rate of power. Moreover, the portable power devices have to be utilized in cooperation with different transmission wires except the main body to recharge the smart mobile devices, such that the weight of items necessarily carried by the users will be increased and the load to the user will be greater.

Accordingly, there is still a need for a solution which can solve the excessively high rate of power consumption of the traditional smart mobile devices.

### SUMMARY OF THE INVENTION

To solve the aforementioned problems of performance insufficiency or the excessively high rate of power consumption of the traditional smart mobile devices, the present invention provides a cloud-based communication device and a smart mobile device using the cloud-based communication device.

In one aspect, the present invention provides a smart mobile device using a cloud-based communication device, comprising a microprocessor; a built-in operating system implanted in the smart mobile device; a receiving module coupled to the microprocessor to receive display data transmitted from the cloud-based communication device through a network, the display data instructing the smart mobile device to display a graphical user interface of a virtual operating system or program, wherein the built-in operating system is different from the virtual operating system or program; a display module coupled to the microprocessor to display the graphical user interface of the virtual operating system or program according to the display data; a control module coupled to the microprocessor to input and generate control signals based on the graphical user interface of the virtual operating system or program; and a transmission module coupled to the microprocessor to transmit the control signals to the cloud-based communication device through the network.

In another aspect, the present invention provides a cloud-based communication device, comprising a processor; a primary operating system implanted in the cloud-based communication device; a virtual operating system or program executed by the processor and generating display data, wherein the primary operating system is different from the virtual operating system or program, the display data instructing a smart mobile device to display a graphical user interface related to a smart mobile device operating system or a smart mobile device program simulated by the virtual operating system or program; a transmission module coupled to the processor to transmit the display data to the smart mobile device through a network; and a receiving module coupled to the processor to receive the control signals transmitted from the smart mobile device though the network to control the graphical user interface of the virtual operating system or program.

One advantage of the present invention is that the power consumption rate of the terminal smart mobile device will be decreased and the usage duration will be extended.

Another advantage of the present invention is that if the terminal smart mobile device is lost, the data will not be leaked out, such that the security and the data protection are enhanced.

Still another advantage of the present invention is that the user only needs to change a new terminal smart mobile device and then can employ most of the application programs and the data immediately, if the terminal smart mobile device is lost.

Yet another advantage of the present invention is that the problem that traditional smart mobile devices cannot execute large and complex application programs can be solved.

Still another advantage of the present invention is that the user needs not to copy data between different terminal smart mobile devices in order to keep them synchronous, and the continuity of business or non-business affairs can be upgraded.

These and other advantages will become apparent from the following description of preferred embodiments taken together with the accompanying drawings and the appended claims.

### BRIEF DESCRIPTION OF THE DRAWINGS

The present invention may be understood by some preferred embodiments and detailed descriptions in the specification and the attached drawings below. The identical reference numbers in the drawings refer to the same components in the present invention. However, it should be appreciated that all the preferred embodiments of the invention are provided only for illustrating but not for limiting the scope of the Claims and wherein:

FIG. 1 illustrates a block diagram of a cloud-based virtual smart mobile device system in accordance with one embodiment of the present invention; and

FIG. 2 illustrates a block diagram of a terminal smart mobile device in accordance with one embodiment of the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

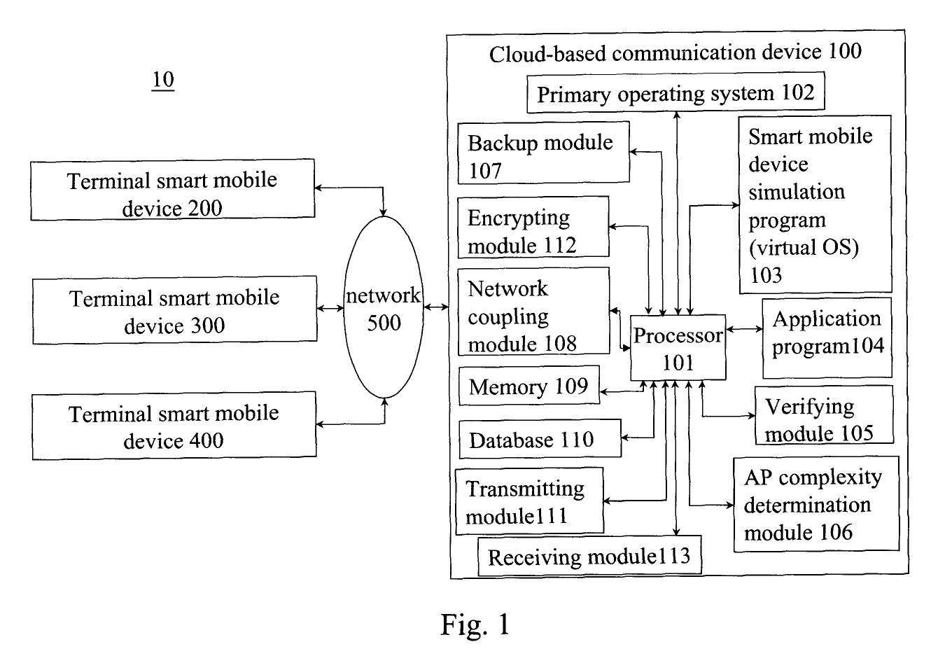

The present invention discloses a cloud-based virtual smart mobile device system 10. As shown in FIG. 1, the cloud-based virtual smart mobile device system 10 of the present invention includes a cloud-based communication device 100, one or more terminal smart mobile devices, and network 500. In another embodiment, more than one cloud-based communication device 100 may also be disposed. The cloud-based communication device 100 is coupled to the network 500 by wire or wirelessly. The network 500 may include, but be not limited to, internet, mobile communication network, wide area network (WAN), or metropolitan area network (MAN). The mobile communication network may include, but be not limited to, 3G mobile communication network, 3.5G mobile communication network, and 4G mobile communication network.

In one embodiment of the present invention, the present invention includes three terminal smart mobile devices, for instance a terminal smart mobile device 200, another terminal smart mobile device 300 and a further terminal smart mobile device 400. The device number mentioned above is described to illustrate the present invention but not to limit the present invention. Thus, any number more than one of terminal smart mobile devices may be performed. The terminal smart mobile device 200, the terminal smart mobile device 300 and the terminal smart mobile device 400 are all coupled to the network 500 respectively, so as to be further coupled to the cloud-based communication device 100 through the network 500. The terminal smart mobile devices 200, 300 and 400 may include, but be not limited to, smart phones, tablet PCs, personal digital assistants (PDAs), notebooks (NBs) or netbooks, such as iPad and iPhone manufactured by Apple Computer, Inc., HTC Desire manufactured by HTC corp., HTC Legend manufactured by HTC Corp., etc.

As shown in FIG. 1, the cloud-based communication device 100 (which may be configured according to a server architecture) includes a processor 101, a primary operating system 102 and a smart mobile device simulation program (also referred to as a smart mobile device virtual operating system (OS)) 103. The primary operating system 102 and the smart mobile device simulation program (the smart mobile device virtual operating system) 103 are coupled to the processor 101 respectively. The primary operating system 102 is the main and general-purpose operating system for the cloud-based communication device. In one embodiment, the primary operating system 102 may include, but be not limited to, Windows server 2008, Windows server 2003 and Linux. The smart mobile device simulation program (the smart mobile device virtual operating system) 103 is a virtual operating system to simulate various kinds of smart mobile devices, or a simulation program to simulate different kinds of operating environments dedicated to the smart mobile devices, including simulation of graphical user interfaces (GUIs) dedicated to the smart mobile devices. After the smart mobile device simulation program (the smart mobile device virtual operating system) 103 is executed by the processor 101, display data may be generated. The primary operating system 102 is different from the smart mobile device virtual operating system (the smart mobile device simulation program) 103. The display data instruct the terminal smart mobile devices 200, 300 or 400 to display the graphical user interfaces for different kinds of smart mobile devices simulated by the smart mobile device virtual operating system (the smart mobile device simulation program) 103. The icons, the windows, the menus and the buttons in the graphical user interfaces for smart mobile devices simulated or calculated by the smart mobile device simulation program (the smart mobile device virtual operating system) 103 are designed to correspond to various kinds of smart mobile devices, so as to be displayed on the display module of the terminal smart mobile devices 200, 300 or 400. Therefore, the terminal smart mobile devices 200, 300 or 400 not only have the graphical user interface configured by the built-in operating system thereof, but also simulate the graphical user interfaces for other different operating systems of smart mobile devices. The computation may be computed in the cloud-based communication device 100 based on the demands.

As shown in FIG. 1, the cloud-based communication device 100 further includes application programs 104 and a verifying module 105 and optionally includes an application program complexity determination module (also referred to as AP complexity determination module) 106. The application programs 104, the verifying module 105 and the application program complexity determination module 106 are coupled to the processor 101 respectively. The application programs 104 may include, but be not limited to, document application programs, entertainment application programs, electronic book application programs, social network application programs, game application programs, web call application programs, music application programs, business application programs, news application programs, navigation application programs, photography application programs, web browser application programs, short message application programs, electronic wallet application programs, etc. The application programs 104 may be executed in the operating systems or operating environments for the smart mobile devices simulated by the smart mobile device simulation program (the smart mobile device virtual operating system) 103. The verifying module 105 is utilized to verify the identity of the user by enquiring the user who desires to login the cloud-based communication device 100 to key in the user name and the password for personal identity verification. If the user name and the password keyed in by the user are correct, the user may login the cloud-based communication device 100.

In one embodiment, the application program complexity determination module 106 is employed to determine how complexity of the application program selected by the user is after the user logins the cloud-based communication device 100. If the complexity determination result of the selected application program is higher than a predetermined value, the selected application program is executed in the cloud-based communication device 100. If the determination result of the complexity of the selected application program is lower than the predetermined value, the install file for the selected application program will be searched out from the database 110 and will be transmitted to and installed in the terminal smart mobile device 200, 300 or 400 used by the user, and the selected application program will be executed in the terminal smart mobile device 200, 300 or 400.

As shown in FIG. 1, the cloud-based communication device 100 further includes a backup module 107, a network coupling module 108 and a memory 109. The backup module 107, the network coupling module 108 and the memory 109 are coupled to the processor 101 respectively. The backup module 107 is utilized to automatically backup all of the data in the cloud-based communication device 100, for instance the data of the primary operating system 102 and the application programs 104, including but are not limited to system files, telephone books, text files, image files, multimedia files, user names and passwords for social networks, games and web calls, music files, map data, photo files, web browsing history files, website bookmarks, short messages, electronic authentication data, credit card numbers, expiry dates of credit cards, coupon data, etc. Therefore, when the user changes the smart mobile device, the user can employ the new smart mobile device to connect the cloud-based communication device 100 at any time, copy part of or all of the data from the cloud-based communication device 100 into the new smart mobile device and further download all settings simultaneously.

The network coupling module 108 is utilized to couple with the network 500. The network coupling module 108 may include a wired network coupling module and/or a wireless network coupling module. In one embodiment of the present invention, the wireless network coupling module may include but be not limited to a 802.11x standard module, a Wi-Fi standard module, a 3G standard module, a 3.5G standard module, and a 4G standard module. The memory 109 is utilized to store the data of the primary operating system 102 and the application programs 104, including but are not limited to system files, telephone books, text files, image files, multimedia files, user names and passwords for social networks, games and web calls, music files, map data, photo files, web browsing history files, website bookmarks, short messages, electronic authentication data, credit card numbers, expiry dates of credit cards, coupon data, etc.

As shown in FIG. 1, the cloud-based communication device 100 further includes a database 110, a transmission module 111, an encrypting module 112 and a receiving module 113. The database 110, the transmission module 111, the encrypting module 112 and the receiving module 113 are coupled to the processor 101 respectively. The database 110 is utilized to store the user name data and the password data of different users, lists of application programs ever used or downloaded by the users and install files for the application programs 104. The install files for the application programs 104 may include but be not limited to install files for document application programs, install files for entertainment application programs, install files for electronic book application programs, install files for social network application programs, install files for game application programs, install files for web call application programs, install files for music application programs, install files for business application programs, install files for news application programs, install files for navigation application programs, install files for photography application programs, install files for web browser application programs, install files for short message application programs, install files for electronic wallet application programs, etc., in order for the users to download them with the terminal smart mobile device 200, 300 or 400 and install them.

The transmission module 111 transmits the display data to the terminal smart mobile device 200, 300 or 400 through the network 500, so as to render the display module of the terminal smart mobile device 200, 300 or 400 to show the display data and enable the users to see the graphical user interfaces for the smart mobile devices simulated by the smart mobile device simulation program (the smart mobile device virtual operating system) 103. The encrypting module 112 utilizes encryption algorithms to encrypt the data stored in the memory 109 and the database 110, so as to insure the security of the data. The receiving module 113 receives the control signals from the terminal smart mobile device 200, 300 or 400 through the network 500 to control the graphical user interfaces for the smart mobile devices simulated by the smart mobile device simulation program (the smart mobile device virtual operating system) 103.

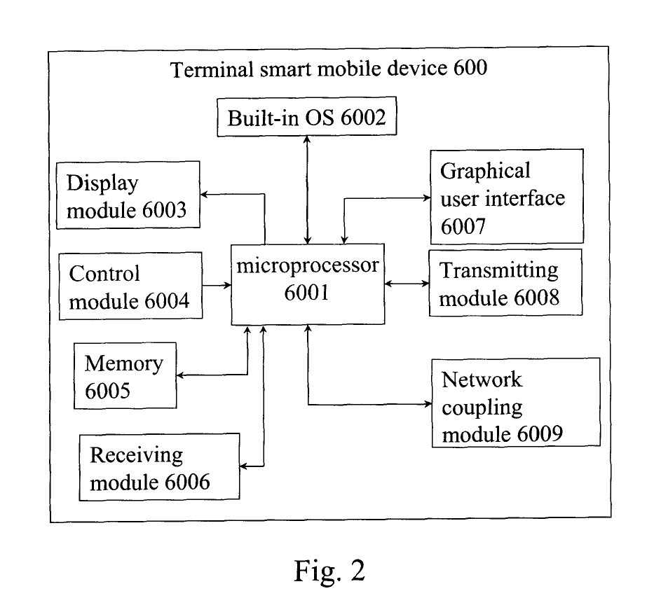

FIG. 2 is an exemplary embodiment of the terminal smart mobile device 200, 300 or 400 in FIG. 1, for illustrating the present invention but not for limiting the present invention. Therefore, the embodiment in FIG. 2 may also be added with a RF (radio frequency) module, antennas, a global positioning system and/or a near-field communication chip, etc., which is coupled to the microprocessor. As shown in FIG. 2, in one embodiment of the present invention, the exemplary terminal smart mobile device 600 includes a microprocessor 6001, a built-in operating system (built-in OS) 6002, a display module 6003, a control module 6004, a memory 6005, a receiving module 6006, a graphical user interface 6007, a transmission module 6008 and a network coupling module 6009. As usual, the built-in operating system 6002, the display module 6003, the control module 6004, the memory 6005, the receiving module 6006, the graphical user interface 6007, the transmission module 6008 and the network coupling module 6009 are all coupled to the microprocessor 6001, respectively. In one embodiment, the built-in operating system 6002 may include but be not limited to Windows mobile, iOS, Symbian, Linux, Palm OS, BlackBerry OS, Windows XP, Windows 7, Windows Vista. The Linux operating system may include but be not limited to Android, Maemo and WebOS. In one embodiment, the built-in operating system 6002 is different from the smart mobile device virtual operating system (the smart mobile device simulation program) 103. The display module 6003 is employed to display the graphical user interface 6007, data screens and the graphical user interfaces for the smart mobile devices simulated by and transmitted from the smart mobile device simulation program (the smart mobile device virtual operating system) 103 of the cloud-based communication device 100. The display module 6003 may include but be not limited to liquid crystal display (LCD) module, LED (light emitting diode) backlight display module.

The control module 6004 may input texts or symbols, control cursors, or click icons or buttons based on the graphical user interfaces simulated by the smart mobile device simulation program (the smart mobile device virtual operating system) 103. The control module 6004 may include but be not limited to pointing devices and keyboards. The pointing devices may include but be not limited to trace balls, touch panels, touch modules, joysticks, pointing sticks, light pens, etc. The memory 6005 is employed to store the data of the built-in operating system 6002 and the install files for the application programs downloaded from the cloud-based communication device 100. The receiving module 6006 receives the display data transmitted from the cloud-based communication device 100 through the network 500. The display data instruct the terminal smart mobile device 600 to display the graphical user interfaces simulated by the smart mobile device simulation program (the smart mobile device virtual operating system) 103. The transmission module 6008 transmits the control signals inputted by the users via the control module 6004 to the cloud-based communication device 100 through the network 500, so as to control the application programs 104 executed in the cloud-based communication device 100 and the graphical user interfaces simulated by the smart mobile device simulation program (the smart mobile device virtual operating system) 103. The network coupling module 6009 is utilized to couple with the network 500. The network coupling module 6009 may include a wireless network coupling module. In one embodiment of the present invention, the wireless network coupling module may include but be not limited to a 802.11x standard module, a Wi-Fi standard module, a 3G standard module, a 3.5G standard module, and a 4G standard module.

In one embodiment of the present invention, more than one of terminal smart mobile devices may connect and login the cloud-based communication device 100 with the same user name and password, so as to obtain the same graphical user interface for the smart mobile device and employ the same or at least the similar usage environment. If more than one of terminal smart mobile devices connect and login the cloud-based communication device 100 with different user names and passwords, different graphical user interfaces for the smart mobile devices will be obtained and different usage environments will be employed. In another embodiment of the present invention, the cloud-based communication device 100 may synchronize with the terminal smart mobile device 200, 300, 400 or 600 completely to render the application programs and related data in the cloud-based communication device 100 and the terminal smart mobile device 200, 300, 400 or 600 totally identical. In other words, virtual smart mobile devices may be formed directly in the cloud-based communication device 100. Thus, when the terminal smart mobile device 200, 300, 400 or 600 cannot connect to the cloud-based communication device 100, the user can still solely utilize the application programs and the related data in the terminal smart mobile device 200, 300, 400 or 600. When the terminal smart mobile device 200, 300, 400 or 600 can connect to the cloud-based communication device 100, the application program complexity determination module 1006 may determine whether the application program selected by the user should be executed in the cloud-based communication device 100 or in the terminal smart mobile device 200, 300, 400 or 600. In another embodiment, the application program selected by the user may be executed completely in the cloud-based communication device 100.

When the user would like to employ the terminal smart mobile device 200, 300 or 400, the terminal smart mobile device 200, 300 or 400 will connect the network 500 through the network coupling module 6009 to further connect to the cloud-based communication device 100. After the user is connected to the cloud-based communication device 100, the verifying module 105 will request the user to provide the user (account) name and the password. After the user inputs the user name and the password through the control module 6004 and the user name and the password are transmitted to the cloud-based communication device 100 through the transmission module 6008, the transmission module 111 will transmit the display data of the graphical user interface for the smart mobile device belonging to the user to the terminal smart mobile device 200, 300 or 400 if the user name and the password are correct, such that the display data will be shown on the display module 6003, accordingly to allow the user to read or see the information.

The user may select desired application programs 104 with the control module 6004, and followed by transmitting the control signals of the control module 6004 to the cloud-based communication device 100 through the transmission module 6008, and the control signals will be received by the receiving module 113, so as to control the cursors on the graphical user interfaces for the smart mobile devices simulated by the smart mobile device simulation program (the smart mobile device virtual operating system) 103 and render the cursors to click the specific application program. After the specific application program is clicked by the cursors, the application program complexity determination module 106 will determine the complexity of the specific application program. If the complexity determination result of the specific application program is higher than a predetermined value, the specific application program will be executed in the cloud-based communication device 100. On the contrary, if the complexity determination result of the specific application program is lower than the predetermined value, the install file for the specific application program will be searched out by the server searching engine from the database 110, and followed by transmitting them to the terminal smart mobile device 200, 300 or 400 used by the user, and the transmitted file is stored in the memory 6005 and installed therein. The specific application program will be executed in the terminal smart mobile device 200, 300 or 400 after installation if desire.

Accordingly, the terminal smart mobile device 200, 300 or 400 of the user only executes application programs with the complexity lower than the predetermined value and needs not to execute application programs with high complexity, thereby the power consumption rate thereof will be decreased and the usage duration will be extended. Most of the data required for the execution of the application programs are stored in the cloud-based communication device 100. Therefore, if the terminal smart mobile device 200, 300 or 400 is lost or missed, the data will not be leaked out, such that the security and the data protection are enhanced. Further, the user only needs to change a new terminal smart mobile device, and subsequently most of the application programs and the data may be accessed by the user immediately when the terminal smart mobile device 200, 300 or 400 is unfortunately lost due to most of the application programs and the related data are stored in the cloud-based communication device 100.

The backup module 107 may backup all of the data in the cloud-based communication device 100 automatically and cyclically. Therefore, the data backuped by the backup module 107 may recover the cloud-based communication device 100 to the original status, when the cloud-based communication device 100 malfunctions. Moreover, the problem that traditional smart mobile devices cannot execute large and complex application programs can be solved since the application programs with high complexity are executed in the cloud-based communication device 100. The present invention enables the user to employ any kinds of application programs in the terminal smart mobile device 200, 300 or 400. Furthermore, as long as the same user name and password are used, the user can employ the same usage environment of the cloud-based communication device 100 with any kinds of terminal smart mobile devices. Thus, the user needs not to copy data between different terminal smart mobile devices in order to keep them synchronous, and the continuity of business or non-business affairs can be upgraded. Further, the user is not required to learn different user interfaces continuously because the user can utilize different kinds of terminal smart mobile device 200, 300, 400 or 600 to connect and login the cloud-based communication device 100 with the same user name and password to have the same usage environment.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A smart mobile device using a cloud-based communication device, comprising:
a microprocessor;
a built-in operating system implanted in said smart mobile device;
a receiving module coupled to said microprocessor to receive display data transmitted from said cloud-based communication device through a network, said display data instructing said smart mobile device to display a graphical user interface of a virtual operating system or program, wherein said built-in operating system is different from said virtual operating system or program;
a display module coupled to said microprocessor to display said graphical user interface of said virtual operating system or program according to said display data;
a control module coupled to said microprocessor to input and generate control signals based on said graphical user interface of said virtual operating system or program; and
a transmission module coupled to said microprocessor to transmit said control signals to said cloud-based communication device through said network.

2. The device of claim 1, wherein said control module comprises a pointing device or a keyboard.

3. The device of claim 2, wherein said pointing device comprises a trace ball, a joystick, a touch panel, a touch module, a pointing stick or a light pen.

4. The device of claim 1, further comprising a network coupling module coupled to said microprocessor to coupled with said network.

5. The device of claim 4, wherein said network coupling module comprises a wireless network coupling module.

6. The device of claim 5, wherein said wireless network coupling module comprises a 802.11x standard module, a Wi-Fi standard module, a 3G standard module, a 3.5G standard module or a 4G standard module.

7. The device of claim 1, wherein said built-in operating system comprises Windows mobile, iOS, Symbian, Linux, Palm OS or BlackBerry OS.

8. The device of claim 1, wherein said built-in operating system comprises Windows XP, Windows 7 or Windows Vista.

9. The device of claim 1, wherein said display module comprises a liquid crystal display (LCD) module or LED (light emitting diode) backlight display module.

10. A cloud-based communication device, comprising:
a processor;
a primary operating system implanted in said cloud-based communication device;
a virtual operating system or program executed by said processor and generating display data, wherein said primary operating system is different from said virtual operating system or program, said display data instructing a smart mobile device to display a graphical user interface related to a smart mobile device operating system or a smart mobile device program simulated by said virtual operating system or program;
a transmission module coupled to said processor to transmit said display data to said smart mobile device through a network; and
a receiving module coupled to said processor to receive said control signals transmitted from said smart mobile device though said network to control said graphical user interface of said virtual operating system or program.

11. The device of claim 10, further comprising an application program complexity determination module coupled to said processor to determine a complexity of an application program selected by a user.

12. The device of claim 11, wherein said application program is executed in said cloud-based communication device when the complexity of said application program selected by the user is higher than a predetermined value.

13. The device of claim 11, wherein an install file for said selected application program is searched out from a database in said cloud-based communication device and is transmitted to said smart mobile device when the complexity of said application program selected by the user is lower than said predetermined value.

14. The device of claim 13, wherein said install file for said selected application program is installed in said smart mobile device.

15. The device of claim 14, wherein said selected application program is executed in said smart mobile device.

16. The device of claim 10, further comprising a backup module coupled to said processor to automatically backup all data in said cloud-based communication device.

17. The device of claim 10, further comprising a verifying module coupled to said processor to enquire a user to key in a user name and a password to verify identity of the user.

18. The device of claim 10, further comprising a database coupled to said processor to store install files for a plurality of application programs.

19. The device of claim 18, further comprising an encrypting module coupled to said processor to encrypt said install files stored in said database.

20. The device of claim 10, further comprising a network coupling module coupled to said processor to couple with said network.
